(19) United States
(12) Patent Application Publication
(10) Pub. No.: US 2002/0186665 A1
(43) Pub. Date: Dec. 12, 2002

(54) Efficient path learning in network

(76) Inventors: Donald Chaffee, Satellite Beach, FL (US); Laurence D'Agati, Melbourne, FL (US); Gary Matthews, Satellite Beach, FL (US)

Correspondence Address: Thomas A. O'Rourke, Wyatt, Gerber & O'Rourke, 99 Park Avenue, New York, NY, 10016, US

(21) Appl. No.: 09/808,635

(22) Filed: Mar. 14, 2001

(51) Int. Cl. H04L 12/28

(52) U.S. Cl. 370/255; 370/351

(57) ABSTRACT

The present invention relates to a network nodes that are interconnected by communication links. Each node is capable of determining communication paths or routes from itself to as many other nodes as possible, either directly or relaying through other nodes, in order to complete the network. These paths are evaluated as new information concerning a route is generated, according to selected criteria, so that the best paths are identified, remembered and used when communication is performed. This invention is concerned with the determination of best paths through a network and the maintenance of these paths as communication conditions and node population changes.

### FIELD OF THE INVENTION

The present invention relates to a method and apparatus for ascertaining the best paths for message flow through a network comprised of nodes and interconnecting communication links and, more particularly, to a technique which enables these nodes to efficiently determine the best paths and pass the necessary information to neighboring nodes so that they can also determine the best paths from their individual viewpoints.

### DESCRIPTION OF THE PRIOR ART

Conventional wireless networks typically permit nodes to communicate only if they are within range of each other. Buildings and geographical features such as hills and valleys can affect the range of various nodes in a wireless network. In addition, differing amounts of traffic at each node as well as other factors can create traffic allocation issues between the nodes. These traffic issues are not just encountered in wireless networks but in other types of networks as well.

Sophisticated software protocols are typically required to control message traffic to permit communication from one cell to another. Such protocols typically add substantial overhead to the network communications. Also, to provide sufficient communications range, such systems typically require each node to have relatively powerful transmitters to communicate with all nodes in the network. However, even when relatively powerful transmitters are used, communications may be interrupted when the source node, destination node or communication link fails. Moreover, such systems are limited by the distance and direction to the destination node from the source node, and, as a result, complicated routing information must be transmitted periodically to all nodes in the network. It will be appreciated that where the routing information that is being transmitted relates to all the nodes in a network, the amount of this information can be rather large thereby leaving less of the network's resources available for its primary responsibility of transmitting communications.

There has been a lot of work in the field of routing protocols in wireless networks. Conventional systems address the problem of routing protocols in small to large networks in which the nodes are not known beforehand by identifying the nodes identified only by their “IP addresses”. The associated routing protocols attempt to obtain a path from source to destination for packet communication. Such wireless networks can be classified under two broad categories: cellular network and ad hoc network.

Most of the wireless networking technologies in development or in the standardization process today are intended to provide wireless devices with access to large, often wired, networks. These designs will provide the benefits of wireless freedom and roaming to those users that wish to access public networks, such as the Internet, and private networks. As such, a hierarchy of devices is envisioned where the wireless terminal is viewed as an extension of a wired network. In a cellular network there are a few special nodes (commonly referred to as base stations) spread over an area. These “special nodes” can communicate among themselves via wired network, a satellite, higher transmit power, etc. The users that normally have lower transmit power communicate with one of these special nodes. If there is a need to communicate with other wireless nodes, then message data is exchanged via other special nodes. However, there are several protocols to keep track of, such as, where the nodes are and what happens when nodes move from one cell to another. Standards, such as the IEEE 802.11 wireless LAN standard, define access points that have the responsibility of communicating information received from wireless terminals to other types of transport networks, wired, wireless or optical. These access points assume the responsibility of managing the wireless terminals in their area and control admission to the network and also govern the timing of local transmissions. The access point must be in direct communication with each wireless terminal in its area and operates somewhat like a Base Station in a cellular network.

In an ad hoc network on the other hand, there are no known special nodes. These networks do not specifically require the support of an additional network but, rather, require the interconnection of a group of wireless devices that desire to communicate among themselves. The data that is to be communicated may originate at one or more of the devices or may come from another network connected to the wireless network through one or more nodes. The network among the nodes has to first establish itself. Nodes exchange messages to find neighbors and other information about neighbors. Some protocols require frequent exchanges of node positions, links, etc. and, based on that information, all nodes attempt to keep optimized updated paths to all other nodes in the network. Other sets of protocols do not keep updated path information, but when a source node needs to communicate with a specific destination, the destination node will be searched for. Most protocols are based upon minimizing either the number of relays along a path or the time delay along the path. These protocols suffer from the fact that in networks with unreliable communication links the best path is often not the shortest path. Shortest paths typically select the longest single communication links which are usually the least reliable and subject to numerous retransmissions in order to reliably deliver a packet from one node to the next node.

### OBJECTS OF THE INVENTION

It is desired to provide a communications system with simple software protocols for controlling message traffic that are concise enough without adding significant overhead to the communications system. Such protocols should also allow ad hoc communications among the nodes in an ad hoc wireless network without regard to the proximity of the other members of the network, particularly the destination node. This invention permits path selection to be based on a number of parameters, which provides significantly better results that a path selection method that is based merely on a minimization of the number of relays or the path delay by evaluating the total cost of communication from source to destination.

In prior art networks, each node attempts to obtain information about every other node in the network. The volume of this information can place burdens on system resources. When additional nodes or additional parameters are added to the network the volume of information that each node processes increases exponentially. This exponential increase in information is eliminated in the present invention and the addition of new nodes or additional parameters creates only a linear increase in the required information.

### SUMMARY OF THE INVENTION

The present invention relates to a network, preferably a self-organizing network of network nodes that are interconnected by communication links. It is not necessary for all nodes to be capable of direct communication with all other nodes. Rather, each node is capable of determining communication paths or routes from itself to as many other nodes as possible, either directly or relaying through other nodes, in order to complete the network. These paths are evaluated as new information concerning a route is generated, according to selected criteria, so that the best paths are identified, remembered and used when communication is performed. This invention is concerned with the determination of best paths through a network and the maintenance of these paths as communication conditions and node population changes.

The method of determining the best path employs within each node a common algorithm that solves the routing problem from each individual node's viewpoint. When numerous nodes are deployed there will usually exist a great many possible paths through the network from one node to some distant node. Selection of the best, second best, third best, etc. path through the network is done according to this invention by choosing the path that minimizes a selected cost function. The cost function is composed of an arbitrary number of metrics that are defined by the goals of the particular network. These metrics may include, but are not limited to, such parameters as the number of nodes that a message must pass through before reaching the destination node, the probability of successful transmission though a route, the worst probability of successful transmission in a segment of the route, the traffic burden on individual nodes in the network etc.

This invention may generally employ two types of metrics and variations thereof depending on the user's chosen, weighted importance of the various parameters to the type of transmission. For example, one set of parameters may be more important for determining the best path for voice communications and another set of parameters are more pertinent for data communications. The first type of metric evaluates a path by selecting a parameter and basing the decision on whether a given route, is the best route for the transmission based on the single weakest or the single best point along the path. The second type evaluates a path by determining a quality measure of the entire path from source to final destination and basing the decision on the route that has the overall best value for the transmission. An example of the first metric type would be the determination of the most congested node along the path or the highest probability of successful transmission. An example of the second type would be the calculation of the number of relays along the path. Another example of the second type would be where a value is determined for each of a selected group of parameters and based on the relative value of each parameter a weighted computation is made to determine the best route along the path. It will be appreciated by those skilled in the art that the parameter or parameters selected can vary as can the weight given each parameter in determining the best path at any given time.

No matter which metric or variation thereof is employed, all information necessary to select the best path from a source node to a final destination node is learned preferably only from the nodes that are in direct communication with the source node. This is because usually, the only capability that any node, acting as a source, has is to communicate with its neighbors. Thus, an original source node must select the neighbor node on the best path to the final destination. The determination of the best path is based on the selected parameters. The selection of the first node in the chain to the destination depends on the data generated by each node in calculating the best path to each of the other nodes in the network based on the information received from adjacent nodes. Once the message is passed, the original source node can provide no further influence on the path of the message. At this point the selected neighbor becomes the new source for the message while the final destination remains the same. This neighbor repeats the process of path selection as was performed by the original source. This process repeats until the message reaches the final destination node.

Learned information that is used for path selection is preferably maintained in a table in each node. Each row in the table is indexed by a final destination and each column contains that node's computation of a specific metric for the path to that destination. The information that is placed in a node's table is determined by processing information from each neighbor's table. An example of this process according to the invention is as follows. Assume that the cost of a path is composed of two metrics, the number of messages waiting for transmission at the most congested node on the path and the number of relays from source to destination. These metrics would be communicated from a node to a neighbor by defining the final destination of the path, the maximum of (the message count metric for the path OR its own message count), and the number of relays on its best path to the final destination. The receiving node would increase the number of relays by one to include the neighbor as an additional relay and compute the cost of communicating to the final destination via this neighbor using the two metrics. This would be compared to the cost of the stored best path for that destination and the table would be updated with the selected new best path.

Metrics may be sent to neighbor nodes as a separate transmission or by concatenation with normal message traffic. When the metrics are sent in a separate message (such as when a broadcast channel is available) the user messages are communicated with overhead typically limited to the network source or originating node of the communication, the link source and the link destination of the communication and the network destination for the communication. They can also be sent in specific messages during times of low message activity or when specifically requested by a neighbor. When metrics are sent to neighbors according to the invention, one or more table rows are placed in a message. The rows selected are preferably prioritized according to the time of their last update from their last transmission. This speeds the flow of new information through the network. The messages can be directed to a specific neighbor but can be viewed by all neighbors simultaneously. All neighbors preferably accept table row information as broadcast information and process it accordingly regardless of the neighbor designated as the next destination for the remainder of the message.

Using the methods of the invention, a node selects the best neighbor node to which a message is sent that is to go to some final destination. The node has selected this first relay based upon all available information. The problem of message delivery now falls upon the selected neighbor and the process is repeated. Short paths are obviously solved. For long paths involving numerous relays and unreliable communication links the path may change as the message progresses. This is unimportant to the originating node since this information is unavailable. What is important is that the message started in the right direction and its path will be continually optimized as it progresses through the network. By the time it arrives in the vicinity of the final destination node, those nodes in the path that the message has traveled will have learned and updated their paths to that destination node.

### BRIEF DESCRIPTION OF THE DRAWINGS

FIG. 1 is an example of paths through a network.

FIG. 2 is a graphical comparison of several link cost functions.

FIG. 3 shows communicating routing information between neighbors.

FIG. 4 is a representation of the ‘Cross’ Scenario.

FIG. 5 is a flow chart showing an example of the steps employed by nodes in determining the best path.

FIG. 6 is a flow chart showing an example the updating of a routing table for a node based on information received from some of its neighboring nodes.

### DETAILED DESCRIPTION OF THE PREFERRED EMBODIMENT

Network Nodes

The network of the present invention may include any network as that term is used in the art including but not limited to a LAN, WAN, the Internet, a satellite communication system, a ground communication system, etc. The term node as used herein may include but is not limited to a cell phone, a base station, a military base station etc. The node of the present invention should have a computing capability, memory, and an ability to communicate with one or more other nodes. One of the advantages of the present invention is that the computing capability of the nodes does not have to be very great. In many instances even an 8-bit processor will provide sufficient computing power for the practice of the present invention. The ability to communicate may be by any means including but not limited to radio, a fiber optic network, wired, etc.

In the network defined herein, a node may perform a function similar to that of a packet switch and preferably will automatically establish and maintain a packet communication network. Each node may have several input channels and several output channels that could be defined, for example, by frequency, time slot, or spreading code. Nodes will maintain input and output channels to other nodes via communication links.

Since packets are not necessarily transmitted as they are received, they may have to be stored at least until the next available transmit time. They typically will be accumulated in a waiting queue. Further, since communication links are not 100% reliable, there may be a need for retransmission of packets that fail to reach the next node. These packets will be stored in, for example, a retransmission queue. Two separate queues are preferably maintained so packets awaiting retransmission can be treated differently from new packets, if desired. Usually, no firm assignments are made between queues and output channels. Any packet can compete for any channel in the packet selection process. The nodes of the present invention also preferably have a waiting queue and a retransmission queue.

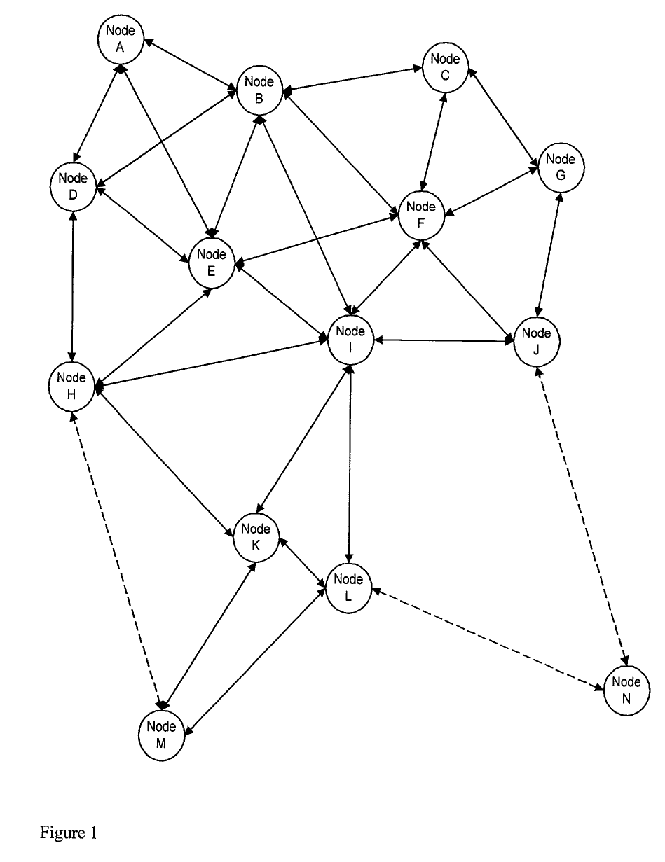

Any node that is capable of receiving the transmissions of another node is considered to be a neighbor of that node or an adjacent node. FIG. 1 shows an example of a collection of nodes that are geographically arranged about some area. Nodes are illustrated with circles. Communication links are shown using lines with two arrowheads representing bidirectional communication. Weak, or occasional, communication links are shown with dashed lines. In this example, Node F has a neighbor set consisting of Nodes B, C, E, G, I and J. The number of nodes in a network may stay static or may vary over time. Nodes may move physically in and out of the area, may lose power due to, for example, low or dead battery, may have a lost radio link to another node due to interference from structures, geographic features or other things, etc. When nodes physically move throughout an area, or as communication conditions change, the node's list of neighbors will change. Nodes can only communicate with nodes outside of their neighbor sets by sending a message via one or more members of their neighbor set. Propagation of the communication to any number of nodes outside of a neighbor set can be accomplished in this manner.

The first step in path selection for a given node is to learn about the composition of its neighbor set and the communication capabilities of its members. Once this has been accomplished, any node in the system can be addressed by forwarding a message to the appropriate neighbor node, which will relay the message to the final destination or to another node along the path to the final destination. FIG. 1 illustrates that several paths are potentially available from one node to another. The figure further illustrates that the paths can be of differing length (number of relays) and of different quality (probability of successful communication to the destination). Each node may learn the various paths through the network and assess the quality of the paths based on selected criteria so that the best path can be chosen for each communication. For example, assume Node H needs to send a message to Node M. The message could be sent directly, or it could be relayed through Node K. The relay approach would require the use of more communication links but, since these links are of higher quality, it is possible that the likelihood of success would be greater. For some applications where the higher quality of the link is important such as for example, data communications, the route through Node K is the best mode. For other communications where the quality of the link is not as important, the direct route from Node H to node M may be the best. One example of where the quality of the link is not as important but the fewest relays is important is in the area of voice communication. Voice communication, because minimum latency is desired, typically prefers the fewest relays.

Communication of the information necessary to support learning and route decisions is a network overhead function. Since each node preferably only has information about its neighbor nodes less of the network overhead resources are used.

Autorouting

The best path of communication is determined by an autorouter, which may be in the form of software or firmware. Preferably, an autorouter is present in each node. The autorouter determines the best path through a network from any given node to a neighbor node and ultimately to a destination node based on information received from a node's neighbor nodes. The best path is defined by this invention as that path which minimizes the total cost of communication. This cost may have several components. Although several components are illustrated, those skilled in the art will appreciate that there are other components that may be used depending on the type of communication. In addition, the weight given each of the components may vary depending on the application and may vary from time to time even in the same applications.

The cost of communicating a message at a single link along the path will be shown proportional to the average number of message transmissions made at that node before successfully passing the message on to the next node. The autorouter determines the total communication cost of the entire path based on information received from neighbor nodes.

The message cost is a means of automatically routing messages away from nodes where many messages are currently in transit through the network and it becomes desirable to avoid these busy nodes. The message cost provides an estimate of how high the communication cost will be in the near future to pass the messages currently stored in the node along to the various next-nodes. The autorouter evaluates this parameter for the entire path from the particular node to the final destination node based on information received from neighbor nodes or the destination mode where the destination node is a neighbor node.

The memory usage and processor burden costs provide means for avoiding those nodes that have tasks that impose an unusually burdensome usage of the available memory or the processor's computational capability. The memory usage parameter determines the percentage of available memory that is required to support computational and communications tasks. The processor burden is based upon the computational time required for the currently active tasks at the node.

The message count and priority message count parameters provide a direct measurement of the total number of messages and a separate count of priority messages on a path. These parameters give an indication of how busy the path nodes will be in the near future at the process of moving messages to a next node. Another cost element is the path delay, which is embodied in the link count parameter. This parameter is a count of the number of individual communication links required to move the message from the current node to the final node.

The network autorouter uses the individual node parameters to determine a total cost of each path. The best path from the current node to the destination node is then chosen as that path with minimum cost. The central concept required to make an effective autorouter is that each node can obtain the information necessary to make this determination from its neighbor nodes. Thus, a node must only determine the best next-node on the optimum path and then pass the message on to that node where the same process will be repeated. This concept relieves any node from the requirement of knowing the identity of all of the nodes on the best path to the destination node thus typically freeing up system resources for other uses.

As discussed above, the evaluation of any network path can be done by one of two basic methods. One method evaluates the parameters by combining the like parameters from all nodes on the path. The second method evaluates the path based upon the worst node or the best node on the path for a given parameter. Thus, the first method evaluates the capabilities of the entire path while the second method evaluates the path based upon its weakest or its best link.

Communication cost can be evaluated for a path based upon the first method. This is because the parameter being estimated represents the total cost to the network of moving a message from origin to destination. Each node estimates the cost of passing a message from itself to the next node on the path. The total cost of communicating this message is defined as the sum of the communication costs on each link of the path. In order to determine this parameter for each path from an origin to a destination it is only necessary for all nodes to communicate to their neighbors the cost from themselves to each possible destination node. As these values are communicated throughout the network, total path costs are updated with new information until all nodes know the value of the parameter for all paths. Thus, if B is a neighbor of A and the node Z is the final destination, then B must pass to A the cost of communicating from B to Z. A knows the cost of communicating from A to B and would add that cost to the cost of communicating from B to Z to determine the cost of communicating from A to Z via node B.

The link count parameter would be accumulated in an identical manner. Final best path selection would be based upon a weighted sum of all individual cost elements. The weighting of each of the parameters is determined by the user to take into consideration the importance of each of the parameters to the communication.

Message cost is a parameter that determines the communication cost at a node that will be incurred by the transmission of all messages currently stored at that node. As such, this parameter is a means of determining an undesirable node for message transit. Thus, the second method can also be used to evaluate the message cost for a path. The total path message cost in this instance may be defined as the maximum value of the message costs at each node on the path. Thus, a node would receive from a neighbor the message cost for the path through that neighbor. The total message cost for the path can be computed at the neighbor because it has all of the knowledge to evaluate the path message cost. Using the A-Z example above, B is the neighbor that knows the maximum of all message costs along the path from B to Z. B also knows the message cost at node B. Thus, B can determine the maximum of the node message costs for all nodes from B to Z including B, which is the message cost from A to Z. Since A is the starting point on the path under consideration its message cost does not need to be considered in routing decisions for paths from A. Similarly, since Z is the terminus of the communication, Z's message cost also is not a factor in the determination for this parameter.

In a similar manner to message cost, the processor burden, memory usage and message count parameters are evaluated for the various network paths. The total cost of a path would then be computed as the weighted sum of these individual path costs. Each node would then remember several paths to all possible destination nodes as the paths with minimum total costs. Several paths provide options for avoiding future link or node failures.

The autorouter of the present invention performs significantly better than a typical shortest path algorithm of the prior art. As an example, assume that only the communication cost is used in path selection. A significant problem consistently occurs in a shortest path algorithm (such as that described in U.S. Pat. No. 6,130,881 and U.S. Pat. No. 5,142,531) where the path with the least number of links is chosen. If A could communicate to B with one link and B could communicate to C with one link, both with only one transmission, but A could communicate to C with typically three transmissions, the shortest path algorithm would always try to go directly from A to C. The best path algorithm of the present invention would evaluate the A-C path as 3 and the A-B-C path as 2 and would select the A-B-C path because fewer transmissions are necessary. This clearly solves the problem of stretching all links to the breaking point, which is a typical problem when the shortest path algorithm is used.

Best Path Autorouting Algorithm

A store-and-forward network has many different processes ongoing simultaneously. There may be several nodes performing communication at different points throughout the network while other nodes are collecting data or are involved in numerically intensive processing. A best path algorithm for automatically routing messages through the network must consider the status of the communication links and the status of the network nodes. The various network parameters need to be weighed in making routing decisions.

The best path algorithm is defined as that path from originating node to destination node that represents minimum network cost based on the relative values placed on each parameter by the network. The best path process of the algorithm is a function of how network costs are defined. The results of the optimization are a function of how different network cost elements are weighted.

Network Costs

The total network cost of communicating a message from origin to destination can usually be divided into four major components. However, those skilled in the art will appreciate that in some applications additional components may be desired or fewer components. In this example the four components are the cost of communicating, the network load of increased message traffic, the memory storage costs of additional messages at a node, and the cost of message delay through busy nodes or links.

The cost of communicating over an entire path from origin to destination in a store-and-forward packet network is required in order to select the optimum path for a message through the network. Evaluation of the network cost must be accomplished in a relatively simple manner in order to create a practical network. As discussed below, there are practical methods to estimate link and node parameters necessary to compute network costs. Then, a preferred algorithm is identified that determines the network costs of the various paths from the individual link and node costs.

It is important to note throughout the following discussions that the evaluation of network costs is done at each node and that the information communicated and the information stored is specific to each node. The resulting algorithm is completely distributed throughout the network in the autorouter at each node. Each node remembers what it needs to do its job and no more. Usually, no node will know the complete path that any message through the network will take (except for paths with only one link).

Communication Cost

The energy required to transmit a message from any node, j, is a cost of communicating whenever a message is sent. This cost is a function of the message length and will be denoted cⱼ(M). When the message is properly received at the intended destination node, k, that node will transmit an acknowledgment message. The cost is a function of the length of the acknowledgment message and will be denoted cₖ(A). The network cost of this single message transmission over the link between j and k is

cⱼₖ=cⱼ(M)+cₖ(A)

where the explicit cost dependence on message length has been dropped for notational simplicity.

The network cost will increase if the message or the acknowledgment are not properly received. Whenever this happens, the transmit-acknowledge cycle will be repeated. The probability that a transmit-acknowledge cycle will be successful on the link from j to k will be denoted Pⱼₖ. The probability that the cycle will not be successful and have to be repeated is then 1−Pⱼₖ. The total average cost of transmitting a message from j to k can then be written as

Cⱼₖ=Cⱼₖ+(1−Pⱼₖ)²Cⱼₖ+(1−Pⱼₖ)³+ . . . +(1−Pⱼₖ)^{N-1}cⱼₖ

where N is the number of attempts to communicate over the link j-k before that course is abandoned in favor of another action. If the cost of the additional action is denoted Aⱼₖ, then the average cost to the network of the attempt, successful or not, to communicate from j to k is

$${C}_{jk} = {\sum }_{n = 0}^{N - 1} {( 1 - {P}_{jk} )}^{n} {c}_{jk} + {( 1 - {P}_{jk} )}^{N} {A}_{jk}$$

which can be rewritten in the simplified form

$${C}_{jk} = \frac{1 - {( 1 - {P}_{jk} )}^{N}}{{P}_{jk}} {c}_{jk} + {( 1 - {P}_{jk} )}^{N} {A}_{jk}$$

A reasonable assumption about the value of the additional cost of the action required when N communication attempts fail is Aⱼₖ=Cⱼₖ. This assumption basically is that node j will recover by trying to pass the message to a node other than k. The link to this other node may be better or worse than the link to node k but this will probably average out over the long term. With this assumption, the network cost for link transmission can be written as

$${C}_{jk} = \frac{{c}_{jk}}{{P}_{jk}}$$

This equation will be referred to as the link cost equation.

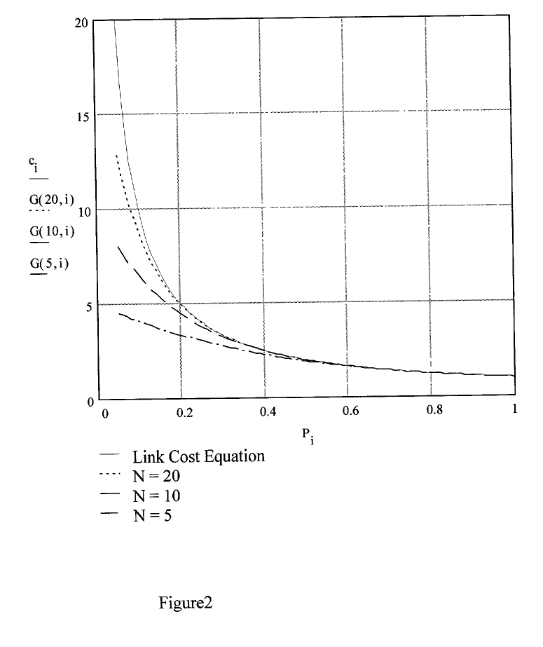

FIG. 2 presents four curves whose relationships will illustrate the concepts involved in the derivation of the link cost equation. The cost, cⱼₖ, is taken as unity for simplicity. The link cost equation is seen to be an upper bound on the other three curves shown. These curves are plots of the equation

$${G}_{jk} ( N ) = \frac{1 - {( 1 - {P}_{jk} )}^{N}}{{P}_{jk}}$$

which represents the network cost of communicating over the link successfully and does not include additional costs for corrective action. The curves are shown for three values of N. When the link success probability is high, all three curves are identical because the likelihood of successful communication with very few repeat transmissions is high. When the link probability drops below about 0.5, then the curve for N=5 starts to fall away from the others because the likelihood of failure with five attempts is becoming significant and there is no failure cost in this curve. The same effect happens to the N=10 and N=20 curves for smaller link probabilities.

FIG. 2 illustrates the values of link probability where failure becomes an important cost issue. Assume the value N=5 will be used in the link logic. With this value, failure begins to become significant at link success probabilities below 0.5. The probability of failure at this point is about 0.03.

Message Costs

Nodes along paths will often have a set of messages that are being stored until they can be transmitted. These may be messages that were generated by tasks at the node or they may be messages that are using the node as a relay along some path. The network's ability to efficiently handle communications can degrade if the messages are not distributed throughout the various nodes. The amount of stored messages in a node should affect the selection of paths that pass through the node.

The network cost of transmitting all of the stored messages in a node can be determined as follows. Let node j have M messages stored in its memory awaiting transmission. For each message, determine the link success probability for transmission to the next node in its path. The cost associated with each of these transmissions is determined by the link cost equation. It will be assumed that the costs of transmission are independent of message length and acknowledgment length. Thus, the numerator in the link cost equation is a constant and can be set to unity. The message cost then can be written as

$${M}_{j} = {\sum }_{k = 1}^{M} \frac{1}{{P}_{jk}}$$

which will be referred to as the message cost equation. This equation provides an estimate of the communication cost to communicate a node's currently stored messages. This cost is a direct function of the amount of time that the node will be expected to spend in the short-term transmitting its stored messages. Thus, the message cost equation provides an indication of the node's short-term communication workload.

The message cost will be defined to be 0 if there are no pending messages at a node. Otherwise, the message cost will be a number that is at least as great as the number of messages stored in the node. The message cost is a single parameter that applies to a node. When message traffic is light the value of this parameter could change quickly with each incoming message. It is beneficial to smooth the message cost parameter to prevent rapid fluctuations in its value. This has the additional benefit of incorporating some past history into the parameter. In this manner, nodes with a recent history of excessive communication workload may be spared additional messages in the short-term.

Since the message cost is lower bounded by the number of messages, this quantity can be quite large. The actual preferred parameter calculated for transmission to neighbors is the average message cost. The message cost can be determined by multiplying the average cost times the number of stored messages which may be another transmitted node status parameter.

Workload Costs

Nodes that have excessive computational burden or that are executing tasks that require large amounts of memory should be given a lower communication burden when possible.

A parameter, named Complexity, is associated with each processor task type. Complexity is meaningful in specifying the computational burden of the task in order to estimate the processor burden at a given node. This parameter would be determined by the person who programs the task's code and may be a function of other task parameters.

The autorouter has an operating system which is present in each node will scan the active tasks in order to determine which to execute next. During this operation, the autorouter using the operating system will accumulate these complexity values. Once accumulated, the sum provides a short term estimate of processor burden. This value can be smoothed to remove the rapid fluctuations. The result is an estimate of the processor burden and is used as a part of the workload cost estimate.

Memory usage can be determined by counting the number of used records in the queues. The result will be an estimate of queue usage. Smoothing these values over time produces an estimate of the percentage queue usage that will be sufficiently accurate for message routing purposes.

Delay Costs

Message paths need to be concerned about total path delay. A round-about path could be chosen solely to avoid a busy node which could result in doubling the time required for message delivery to its destination. For some messages this would be quite acceptable but there are many instances, such as priority messages, when this would be completely unacceptable. Delay costs will be considered only for messages above the lowest priority. Thus, lowest priority messages will be allowed, if not encouraged, to move away from the mainstream message traffic flow whenever possible.

The two components of delay cost are the number of links on the path from origin to destination and the number of priority messages currently stored in the nodes on that path. This provides an indication somewhat proportional to the time that would be required to communicate the message to its final destination.

The number of links on a path is determined from neighbor information. The link parameter is accumulated and passed along with normal communications. The number of priority messages is determined in an identical manner to the number of links. Both are parameters of a path and reflect the time delay a priority message should expect on that path.

Total Network Cost

The total network cost of communicating over a path, P, from node j to node m is expressed as the weighted sum of the cost components described above. This cost can be written as

$${N}_{P} = a \frac{1}{L} {\sum }_{l} \frac{1}{{P}_{l}} + b {max}_{j} ( {M}_{j} ) + c {max}_{j} ( {B}_{j} ) + d {max}_{j} ( {G}_{j} ) + eL + f {\sum }_{j} {C}_{j}$$

where l ranges over the L links in path P

j ranges over the nodes in path P

Bⱼ is the computational burden at node j

Gⱼ is the memory usage at node j

and Cⱼ is the number of priority messages at node j

A message is routed by a node over the available path with minimum Nₚ.

The weighted sum for the network cost of path P is a structure that allows either the network or the user or both to manipulate the influence of the various path, link and node parameters by controlling weights a through f. These weights can be made dynamic so that the logic by which paths are selected can be changed with time as the network conditions change. Also, the weights can be different at different nodes. Since different nodes exist in areas where the communication problems may be different, each node could optimize the path selection logic in a manner best suited to its situation. Thus, the weights a through f may be time and node dependent.

Network Cost Evaluation

The ‘best path’ for a message to take through a network to its final destination can be selected by choosing the path that minimizes the Total Network Cost, Nₚ. Adjustment of the weighting coefficients determines the meaning of the term ‘Best’ for any particular situation. For example, when a network is initially formed there will not be any significant use of node memory nor any build-up of messages in node queues. The ‘Best Path’ will be that which minimizes the communication cost. After the network has been in operation for a while, some nodes may be assigned heavy computational burdens and some nodes may become message bottlenecks. In this case, minimizing communication cost may not be as important as avoiding nodes that are heavily burdened for one reason or another. This simple example illustrates that the network ‘Best Paths’ depend on the current situation and, hence, ‘Best Paths’ are time-varying. This implies that the network must be continually adapting to changes in the conditions at each node. Therefore, it is not possible to solve the Total Network Cost equation for all nodes and paths and then distribute the solutions to all nodes and declare the problem solved.

Taking the view that the conditions at each node are continually changing and that this implies that the set of ‘Best Paths’ through the network is also continually changing, then a method for learning and updating the stored ‘Best Paths’ at each node is required in order to create a practical network implementation. In order to develop a Best Path algorithm, consider a network that is constructed of N nodes. Examining a typical node, j, it is clear that node j has m neighbors where 0≦m<N and a neighbor is any node where direct communication is possible from node j. If the chosen node has m=0 then it is isolated from the network and cannot communicate with any other node. If the chosen node has m=1 then all of its communication must pass through the one available neighbor in order to reach any destination node. Whereas these concepts may seem trivial, they point out the fact that the communication ability of any node is totally controlled by the capabilities of its neighbors. In fact, the selection of a ‘Best Path’ from our node to any other node is nothing more than choosing the neighbor that is on the ‘Best Path’ and then transferring the message to that neighbor. The neighbor will then evaluate all paths from its point-of-view and determine which of its neighbors is on the ‘Best Path’ to the final destination. Thus, the ‘Best Path’ determined from the originating node may not be the same path when evaluated by the first neighbor because conditions may have changed and not yet communicated to the originating node.

The originating node selects the ‘Best Path’ from its point-of-view and, therefore, makes an optimum routing decision based upon all available knowledge. The same operation will occur at each node along the actual message path. If the network is static and all information at all nodes is current then the ‘Best Path’ decision made at the originating node will be the actual path used. In real applications this will not necessarily be the case, but does not matter. The decision made at each node will be the same regardless of decisions that will be made later along the path. Thus, the node that is selecting the neighbor that is the next node on the ‘Best Path’ to the final destination has no need to know the actual path of the message. Rather, the node will make its decision based upon an assessment of the paths emanating from each of its neighbor nodes to the message destination.

The information that is required for a node to determine the neighbor that is on the ‘Best Path’ to a destination consists of two distinct parts. First is the evaluation of the communication link from the node to its neighbor. Second is the evaluation of the path from the neighbor to the final destination. The learning algorithm refers to the communication and processing of routing information that allows each node to select the neighbor on the ‘Best Path’ to any desired destination. This algorithm can be derived by assuming that all information required by any node exists in the memories of its neighbors. Whereas this information may not be totally current, it is the best available and will be updated as the learning occurs at each node. As learning occurs at each node, the algorithm is re-run to update the information in the Routing Table.

The learning algorithm is shown, for example, using the communication cost parameter. All other parameters in the Total Network Cost equation can be exchanged in a similar manner. In this example of learning, the communication cost of the link from node k to its neighbor node j will be denoted C_{j,k}. The average communication cost (sum of all the link costs on the path divided by the number of links on the path) from node j to node N will be denoted A_{j,N} and the number of links between node j and node N will be denoted L_{j,N}. If node k knows the communication cost of the link to its neighbor j and also knows the communication cost from j to a destination node N then the node can evaluate the communication cost from itself to N using the equation

C_{k,N}=C_{k,j}+A_{j,N}L_{j,N}

where it is seen that the communication cost from k to N is the sum of the cost of the link to the neighbor, C_{k,j}, and the communication cost from the neighbor to the destination N.

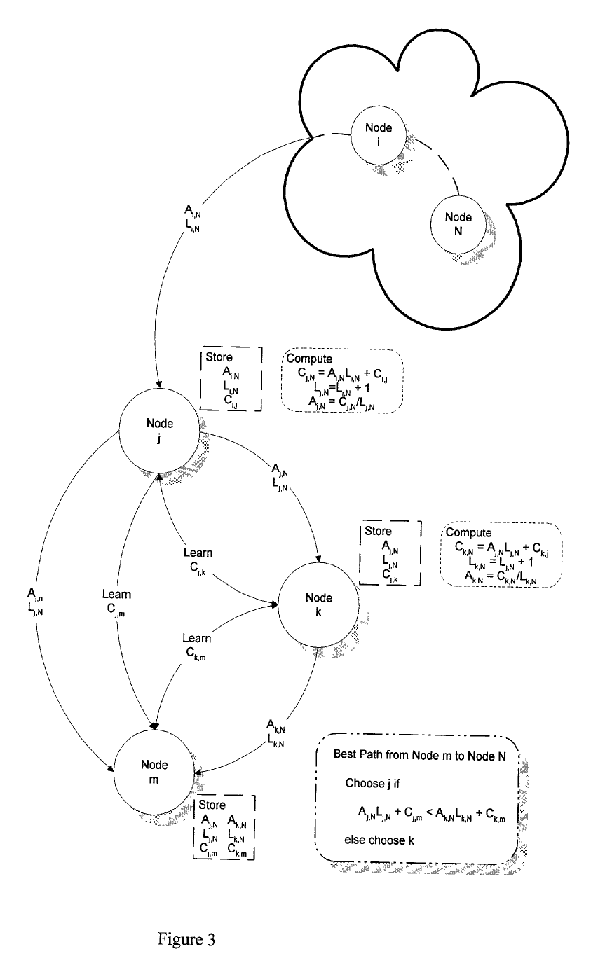

FIG. 3 illustrates an example network where a destination node N is at some unknown location in the network. Node i is a neighbor of node j and has an evaluation of the path to node N. The evaluation is in the form of average communication cost per link, A_{i,N}, and the number of links, L_{i,N}. and is passed to node j. Node j uses this information and its evaluation of the cost of communicating to node i to determine the evaluation parameters for the path from j to N.

Node j communicates the path evaluation parameters to nodes k and m. These nodes are constantly evaluating the communication cost to node j. Thus, at any time, these nodes can compute the communication cost to node N through node j. Node k will also communicate its evaluation of the path to node N, to node m (m will do the same and send to k but this is not shown to simplify FIG. 3). Thus, whenever node m needs to send a message to node N, it can evaluate the communication cost of the ‘Best Path’ via node j and the ‘Best Path’ through k and choose which node is on the ‘Best Path’ at the moment.

This example has shown that the ‘Best Path’ can be determined at a node based upon knowledge gained only from its neighbors and that the path can be chosen based upon the latest knowledge about the link to the neighbor. Once the neighbor has been selected and the message passed, then the message transport problem is passed to the neighbor as well and the neighbor must repeat the ‘Best Path’ determination using the knowledge obtained from its neighbors.

Routing Table

A single routing table is preferably constructed at each node in the network. However, it may at times be desirable to have a second table generated by each node. This second table would contain information for a backup path. A table contains one row for each node in the network. The index of the row (or row number) could be the address of the final destination node. Optionally, the final destination node address could be arbitrary but unique for each node in the network and the table index could be determined from the node's address. The columns of any row contain the final destination address and an arbitrary number of next node addresses depending on the desired number of back-up paths to be saved. For each next node a complete set of cost metrics are stored in the table. This design allows individual metrics to be updated as new information is received, followed by the recalculation of path cost and re-determination of the best path to the final destination node.

In the row corresponding to the node containing the particular table, the node maintains metrics on its own condition. For example, the number of messages awaiting transmission or the current processor burden estimate.

The variables that are maintained in the example Routing Table are shown in Table 1. The Routing Table has a parameter, Number_Paths that is a system design constant. The

TABLE 1
Composition of an example Routing Table.

| | |
|---|---|
| Public Type Routing_Table | |
| Destination As Integer | ′Address of Destination |
| | node |
| Address As String | ′Arbitrary Address of Node |
| First_Node(Number_Paths) As Integer | ′Address of first node on |
| | this path |
| Total Cost(Number_Paths) As Single | ′Computed Path Cost |
| Path_Length(Number_Paths) As Integer | ′Path length as number of |
| | links |
| Path_Cost(Number_Paths) As Integer | ′Path cost estimate/ |
| | number of links |
| Message_Cost(Number_Paths) As Integer | ′Path message cost |
| Processor_Burden(Number_Paths) | ′Path processor burden |
| As Integer | |
| Memory_Usage(Number_Paths) As Integer | ′Path memory usage |
| Priority_Message_Count(Number_Paths) | ′Number of priority |
| As Integer | messages on path |
| Message_Count(Number_Paths) As Integer | ′Number of messages |
| | on path |
| Changed As Boolean | ′Row has changed since |
| | last transmission |
| End Type | |

Number_Paths refers to the number of possible distinct paths to Destination that are to be remembered, best path and Number_Paths - 1 backup paths. Each such path would have a unique First_Node.

TABLE 2
Fields to support Network Learning.

| Learning | | |
|---|---|---|
| Fields | bytes | |
| XID | 2 | This Link’s Transmitter Addre |
| N | 1 | Number of Router Table Row |
| DID | 2 | Final Destination Address |
| APC | 1 | Average Path Cost |
| PLN | 1 | Path Length |
| PMC | 1 | Path Message Cost |
| PPB | 1 | Path Processor Burden |
| PMU | 1 | Path Memory Usage |
| PMG | 1 | Priority Message Counter |

Message Overhead

When a packet is transmitted it typically will contain additional overhead fields to provide path direction and support network learning. An example of the additional fields to support network learning is shown in Table 2. This field set contains the identity of the transmitting node (XID) and information to support the learning function. A node will select several destination paths from its Routing Table and transmit the information that it has acquired about the paths to its neighbors to support the neighbors' learning. Thus, the information consists of identical sets of fields where each set corresponds to a destination node. The parameter, N, specifies the number of sets contained in the message. The DID identifies the destination node for a set. When received, a node will associate this set with the row in its internal communication directory corresponding to this destination. This row will be updated with the received information as appropriate. When a node transmits the information acquired about the paths to its neighbors or at any other time it can transmit the information inside the message packets or it can be a separate broadcast on some type special broadcast channel available at the node.

Routing Information Distribution

An important feature of the invention is that learning occurs at the point of change to the network. The learning then proceeds outward from that point to the surrounding nodes and beyond. If, for example, the nodes happen to be distributed in a hexagonal arrangement then the progression of learning moves outward to encompass additional nodes much like waves from a drop of water in a pool. Thus, as the radius of the circle increases, the number of nodes affected by the new information grows in proportion to the area of the circle. As a result, the number of nodes that learn about a change varies at a rate that is approximately proportional to the square of the number of transmission cycles. As noted above, the information learned can be passed in a message packet or it can be a separate broadcast on some type special broadcast channel available at the node.

It is also important to realize that learning occurs first in the area of change where it will have the greatest effect on path selection. Packets that are passing through the area will automatically be redirected as necessary through the area of change that may have been totally unpredictable by the packet's source node at the time of first transmission.

Since the learning process that results from a single change can cause changes in several neighbor nodes, the next tier of node learning may result from several nodes adjusting their path selections. Therefore, it is important that learning fields be available for transmitting the changes in more than one path during a single transmission. It has been determined that the transmission of three path changes in a single message packet can handle learning updates efficiently in most situations without incurring a generally unnecessary level of overhead in the transmission.

It is important that the learning portion of a packet be filled with information about paths that have changed over paths that have not changed in order to speed the learning process. Routing Table rows are flagged whenever their contents are modified. Modified Routing Table rows are chosen first when constructing a packet for transmission. This is a more efficient method of transferring information throughout the network than simply cycling through all rows of the Routing Table regardless of activity. This technique emphasizes the transmission of information rather than the transmission of data.

A simulation has been used that allows an operator to create a spatially distributed array of nodes by dragging and dropping symbols throughout an area of a computer screen. Once placed, ‘clicking’ on a symbol provides a menu of options including moving the symbol, viewing a simulated front panel or displaying various memory arrays within the chosen node. Each node is a separate instance of a node object and possesses its own memory arrays for tasks, message queues and routing table. Because each node is an instance of an object, all nodes operate with identical programming code. The simulation provides an opportunity to observe the learning operation in endless possible scenarios.

The link model currently implemented is based strictly on range. Other nodes are either in range and communication is perfect, or out of range and communication never occurs. This simplifies the design of scenarios where some nodes can communicate directly with each other and others cannot.

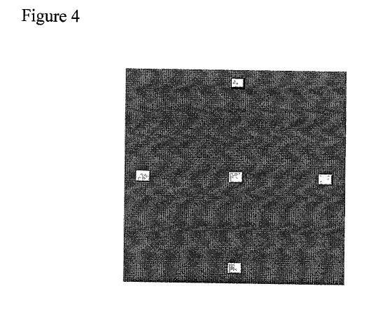

An example scenario is a simple cross. In this scenario, five nodes were placed in the area as shown in FIG. 4. The nodes will be referred to as Left, Center, Right, Top and Bottom indicating their relative positions in the figure. The Center was in range of all other nodes. No other nodes could communicate directly with each other. Thus, any messages between them would have to pass through Center. The simulation was begun and the progress of learning was traced.

The simulation chooses a transmission time at random for each node. A single-step feature was used with the event-driven simulator and the learned paths were recorded at each router after each transmission. The results are documented in Table 3. Simulator time is shown in the first column. The second column shows the node that has transmitted. The third column lists the nodes whose routing table entries are being reported in the transmitted packet. The remaining columns show paths learned by each node as a result of the transmission. Paths are described using three-tuples (x,y,z) which refer to a path to the final destination x can be reached by a path whose next node is y and is of length z. Length refers to the number of RF links over which the message will pass.

At time zero, each node learns about itself since no communication has taken place. By random choice, node 4 (Top) is the first to transmit and can only be received by node 2 (Center). Center learns that a path to Top exists, Top is the next node on that path,

TABLE 3
Learning with time for the Cross Scenario.

| Cross | | | | | | | |
|---|---|---|---|---|---|---|---|
| Scenario | | | | Center- | | | Bottom- |
| time | Tx | Info | Left-1 | 2 | Right-3 | Top-4 | 5 |
| 0 | — | — | (1, 1, 0) | (2, 2, 0) | (3, 3, 0) | (4, 4, 0) | (5, 5, 0) |
| 0.030269 | 4 | 4 | — | (4, 4, 1) | — | — | — |
| 0.031136 | 5 | 5 | — | (5, 5, 1) | — | — | — |
| 0.047339 | 2 | 2, 4, 5 | (2, 2, 1) | — | (2, 2, 1) | (2, 2, 1) | (2, 2, 1) |
| | | | (4, 2, 2) | | (4, 2, 2) | (5, 2, 2) | (4, 2, 2) |
| | | | (5, 2, 2) | | (5, 2, 2) | | |
| 0.050566 | 3 | 2, 3, 4 | — | (3, 3, 1) | — | — | — |
| 0.059388 | 1 | 1, 2, 4 | — | (1, 1, 1) | — | — | — |
| 0.100269 | 4 | 5, 2, 4 | — | — | — | — | — |
| 0.101136 | 5 | 2, 4, 5 | — | — | — | — | — |
| 0.117339 | 2 | 1, 3, 4 | (3, 2, 2) | — | (1, 2, 2) | (1, 2, 2) | (1, 2, 2) |

and the number of links involved is 1(4,4,1).

The next node to transmit is node 5 (Bottom). The learning results are similar in that only Center can receive the signal and learn a path to Bottom. Next, node 2 (Center) happens to transmit. This router has three communication directory rows to transmit and all represent new information to all other nodes and they all can recieve the message. Node 1 (Left) learns about a direct path to Center and paths to Top and Bottom via Center. Right learns the same information. Top and Bottom learn fewer paths because they are not interested in a path to themselves.

In the next two transmissions, Center learns about direct paths to Right and Left. When it becomes Center's turn to transmit again, the modified routing table rows are selected for transmission (1 and 3) and an unmodified path to 4 is chosen to fill the three-row learning fields. The remaining nodes learn the final needed information and the network is now complete.

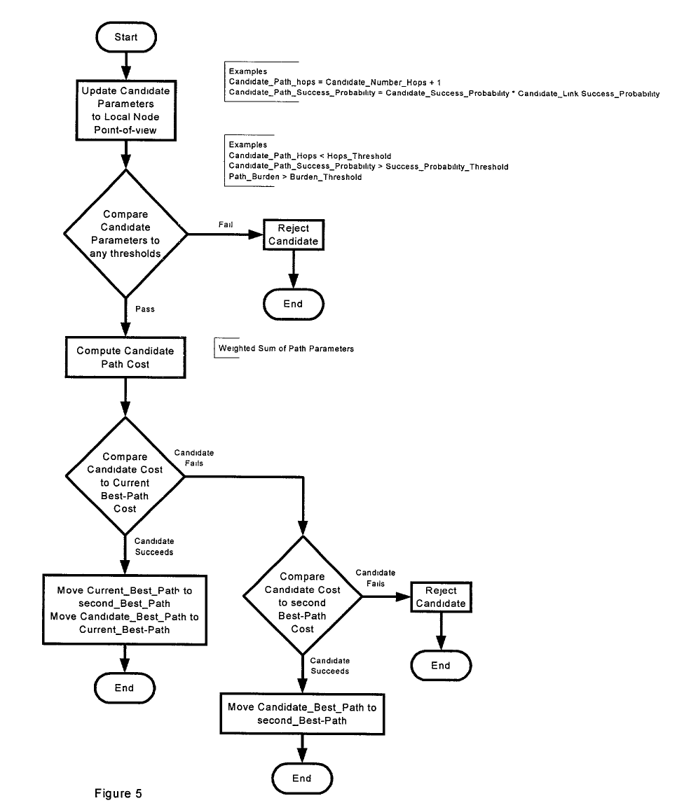

FIG. 5 is a flow chart of an example of the steps for determining the best path for the selected parameters. Once the program starts, the candidate parameters are updated based on the local node's point of view. For example, one parameter is the candidate path hops, which equals the number of candidate hops plus one. The candidates are the possible nodes in the path excluding the source node and the destination node. Another example of a parameter is the candidate success probability. The candidate path success probability equals the candidate success probability for each link in the path multiplied by the candidate success probability for each other link in the path. Once the candidate parameters are updated, the candidate parameters are compared to any preset thresholds. In any candidate fails to meet the threshold value that candidate is rejected. Other parameters are also possible depending on such things as the type of network, the type of nodes, the types of messages, etc. For those candidates that pass the candidate path cost is determined. The candidate path cost is a weighted value of each of the parameters for each path. The value of each individual parameter in the weighted value is determined for the network and this value may vary over time depending on the type of communication and other factors. The value may be a weighted sum of the parameters or based on some other formula. Each of the candidates path cost is compared to the current best path cost or to the other candidate's path cost if there is no previous best path cost determination at the node. Where the candidate's path cost is better than the is current best path cost the current best path cost will be replaced by the candidate's path cost and the displaced best path cost will drop to second best path cost thereby replacing the previous value. Similarly, where the candidate's path cost is better than the current second best path cost, but not better than the current best path cost, the second best path cost will be replaced by the candidate's path cost. If the candidate best path cost is not better than the best or second best path cost than the candidate's path cost is rejected. It will be appreciated by those skilled in the art that additional past cost besides the best and second best costs may be retained by each node if so desired.

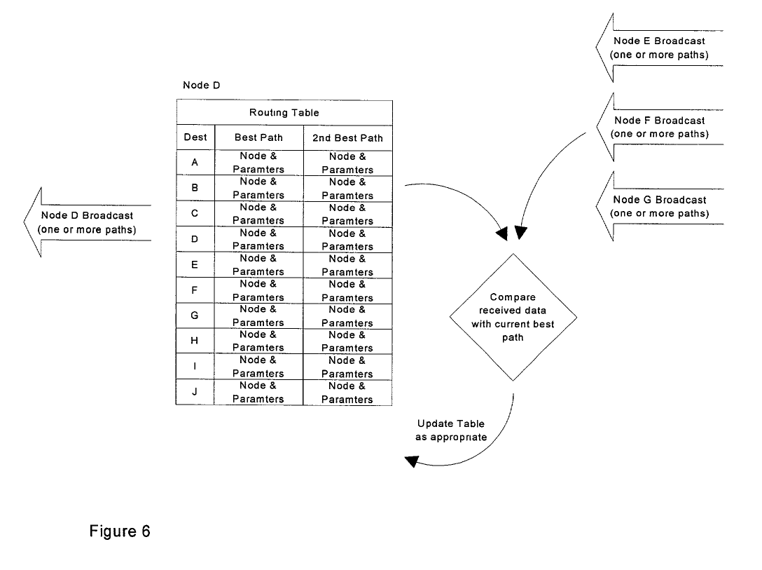

In FIG. 6, for example, node D receives information broadcast from neighboring nodes E, F, and G concerning one or more paths. Node D compares the received information to the best path information presently in node D's routing table for these nodes and updates node D's table if any of the newly received information shows there is a better path than the best path or second best path presently identified in the routing table. Node D broadcasts the updated data to its neighboring nodes.

1. A network comprising a plurality of nodes wherein each of said nodes has a memory, a computing capability, and an ability to communicate with one or more other nodes wherein a communication sent from a source node to a destination node is sent along a path containing one or more nodes wherein each of said nodes in said path that receives said communication determines the best path for said communication to the destination node through a neighboring node based on information received from each neighboring node.

2. The network according to claim 1 wherein communication paths are re-evaluated as new information concerning a path is generated by neighboring nodes.

3. The network according to claim 2 wherein the best path is one that minimizes a selected cost function.

4. The network according to claim 3 wherein the cost function is composed of one or more metrics that are defined by the goals of the particular network.

5. The network according to claim 4 wherein the metric includes the number of nodes that a message must pass through before reaching the destination node.

6. The network according to claim 4 wherein the metric includes the probability of successful transmission though a route.

7. The network according to claim 4 wherein the metric includes the worst probability of successful transmission in a segment of the route.

8. The network according to claim 4 wherein the metric includes the traffic burden on individual nodes in the network.

9. The network according to claim 4 wherein a path is evaluated by selecting a parameter and basing the decision on whether a given route is the best route for the transmission based on the single weakest point along the path.

10. The network according to claim 4 wherein a path is evaluated by selecting a parameter and basing the decision on whether a given route is the best route for the communication based on the single best point along the path..

11. The network according to claim 4 wherein a value is determined for each of a selected group of parameters and based on the relative value of each parameter a weighted computation is made to determine the best route along the path.

12. The network according to claim 11 wherein the information concerning a path for a communicating a message from a node is determined by said node only from communications from the nodes that are in direct communication with said node

13. The network according to claim 9 wherein the information concerning a path for a communicating a message from a node is determined by said node only from communications from the nodes that are in direct communication with said node.

14. The network according to claim 1 wherein the selection of the first node in a chain of nodes to a destination node depends on data generated by each node in calculating the best path to each of the other nodes in the network from information received from adjacent nodes.

15. The network according to claim 2 wherein information that is used for path selection is maintained in a table in each node.

16. The network according to claim 15 wherein each table has one or more rows indexed by a final destination and one or more columns each containing that node's computation of a specific metric for the path to that destination.

17. The network according to claim 16 wherein the information that is placed in a node's table is determined by processing information from each neighboring node's table.

18. The network according to claim 4 wherein the metrics may be sent to neighbor nodes as a separate transmission.

19. The network according to claim 4 wherein the metrics may be sent to neighbor nodes by concatenation with normal message traffic.

20. The network according to claim 18 wherein changes in the metrics are prioritized according to the time of their last update.

21. A method of transmitting a communication from a source node to a destination node in a network having a plurality of nodes comprising determining the best path for said communication from said source node to the destination node through each neighboring node based on information received from each neighboring node;
transmitting said communication from said source node to a the neighboring receiving node determined to be the best path for said communication to said destination node;
determining the best path from the receiving node to the destination node through each neighboring node based on information received from each of said neighboring nodes;
continuing the steps until the destination node receives the communication.

22. The method according to claim 21 wherein communication paths are re-evaluated as new information concerning a path is generated by neighboring nodes.

23. The method according to claim 22 wherein the best path is one that minimizes a selected cost function.

24. The method according to claim 23 wherein the cost function is composed of one or more metrics that are defined by the goals of the particular network.

25. The method according to claim 24 wherein the metric includes the number of nodes that a message must pass through before reaching the destination node.

26. The method according to claim 24 wherein the metric includes the probability of successful transmission though a route.

27. The method according to claim 24 wherein the metric includes the worst probability of successful transmission in a segment of the route.

28. The method according to claim 24 wherein the metric includes the traffic burden on individual nodes in the network.

29. The method according to claim 24 wherein a path is evaluated by selecting a parameter and basing the decision on whether a given route is the best route for the transmission based on the single weakest point along the path.

30. The method according to claim 24 wherein a path is evaluated by selecting a parameter and basing the decision on whether a given route is the best route for the communication based on the single best point along the path.

31. The method according to claim 24 wherein a value is determined for each of a selected group of parameters and based on the relative value of each parameter a weighted computation is made to determine the best route along the path.

32. The method according to claim 31 wherein the information concerning a path for a communicating a message from a node is determined by said node only from communications from the nodes that are in direct communication with said node

33. The method according to claim 29 wherein the information concerning a path for a communicating a message from a node is determined by said node only from communications from the nodes that are in direct communication with said node.

34. The method according to claim 22 wherein information that is used for path selection is maintained in a table in each node.

35. The method according to claim 34 wherein each table has one or more rows indexed by a final destination and one or more columns each containing that node's computation of a specific metric for the path to that destination.

36. The method according to claim 24 wherein the metrics may be sent to neighbor nodes as a separate transmission.

37. The method according to claim 24 wherein the metrics may be sent to neighbor nodes by concatenation with normal message traffic.

38. The method according to claim 24 wherein changes in the metrics are prioritized for sending to neighboring nodes according to the time of their last update.

39. The method according to claim 37 wherein the forwarding of path metric information throughout the network adds only a relatively small amount of overhead to normally transmitted messages.

40.A node in a network comprising a plurality of nodes, said node having a memory, a computing capability, and an ability to communicate with one or more other nodes, said node being adapted to receive a communication sent from a source node to be sent to a destination node, said node being adapted to send said communication along a path containing one or more nodes wherein said node determines the best path for said communication to the destination node through neighboring nodes based on information received from said neighboring nodes.
